(19) United States
(12) Patent Application Publication
(10) Pub. No.: US 2012/0286907 A1
(43) Pub. Date: Nov. 15, 2012

(54) MULTI-STAGE MAGNETIC SWITCH

(76) Inventor: Wen-Hsuan CHIANG, Taichung City (TW)

(21) Appl. No.: 13/103,243

(22) Filed: May 9, 2011

(51) Int. Cl. H01H 9/00

(52) U.S. Cl. 335/205

(57) ABSTRACT

A multi-stage magnetic switch includes a base and a rotary member rotatably held in the base. The base holds a latch member elastically extended outwards. The rotary member includes a plurality of latch notches. Each latch notch has a latch plane and an arched convex surface which have respectively one side extended to the outer surface of the rotary member. The latch member latches on the latch plane and is adjacent to the arched convex surface. The latch member is pressed and retracted through the latch plane when the rotary member rotates against the base so that the latch member latches on the latch notches sequentially to form multi-stage positioning. Moreover, greater force can be applied to retract the latch member pressed by the arched convex surface to reverse the rotary member. The switch of the invention thus formed has simple structure and makes multi-stage positioning easier.

### FIELD OF THE INVENTION

The present invention relates to a rotary switch and particularly to a multi-stage magnetic switch.

### BACKGROUND OF THE INVENTION

A conventional magnetic working platform generally includes a base, a rotary magnet, and a rotary switch coupled with the rotary magnet so that the rotary magnet can be controlled to rotate up and down for 180 degrees to allow the magnetic working platform to provide two functions of attraction and non-attraction. With advance of technology these days, the magnetic working platform has been developed to provide multi-stage rotation according to various angles of the rotary magnet to adjust the magnetic force at different intensity or achieve varying setting in different magnetic directions.

However, the conventional rotary switch does not have positioning function for multiple stages and has difficulty in controlling the rotary magnet to achieve a precise position during multi-stage angular rotation. Moreover, the conventional multi-stage switch has complex structure and is easily damaged when in use. Furthermore, the conventional multi-stage switch also is costly in production, and has difficulty in coupling with the magnet. Hence it is not applicable to be adopted on magnetic working platforms.

### SUMMARY OF THE INVENTION

The primary object of the present invention is to provide a multi-stage switch with a simple structure.

The present invention provides a multi-stage magnetic switch that includes a base and a rotary member. The base has a bore and a latch groove adjacent to the side wall of the bore. The rotary member is rotatably held in the bore. The latch groove holds a latch member elastically extended outwards. The rotary member has a plurality of latch notches corresponding to and latched with the latch member. Each latch notch has a latch plane and an arched convex surface. The latch plane and arched convex surface have respectively one side extended to the outer surface of the rotary member. The latch member latches on the latch plane and is adjacent to the arched convex surface. The latch member can be retracted by pressing on the latch plane to allow the rotary member to rotate against the base so that the latch member latches on the corresponding latch notches sequentially to form multi-stage positioning. The latch member also can be retracted by pressing on the arched convex surface to reverse the rotary member when greater force is applied to.

By means of the structure set forth above, the rotary member and base are hinged through a simple latch mechanism, and a switch thus fabricated can provide clockwise and counterclockwise rotation, and multi-stage positioning function. The cost is lower and durability is longer, hence can better meet use requirements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a perspective view of the invention.

FIG. 3A is a sectional view of the invention in a latched condition.

FIG. 3B is a sectional view of the invention in a rotated condition.

FIG. 3C is a sectional view of the invention in a removing condition.

FIG. 3D is a sectional view of the invention in a reversing condition.

FIG. 4 is a sectional view of another embodiment of the invention.

FIG. 5 is a sectional view of an embodiment of the invention.

### DETAILED DESCRIPTION OF THE PREFERRED EMBODIMENTS

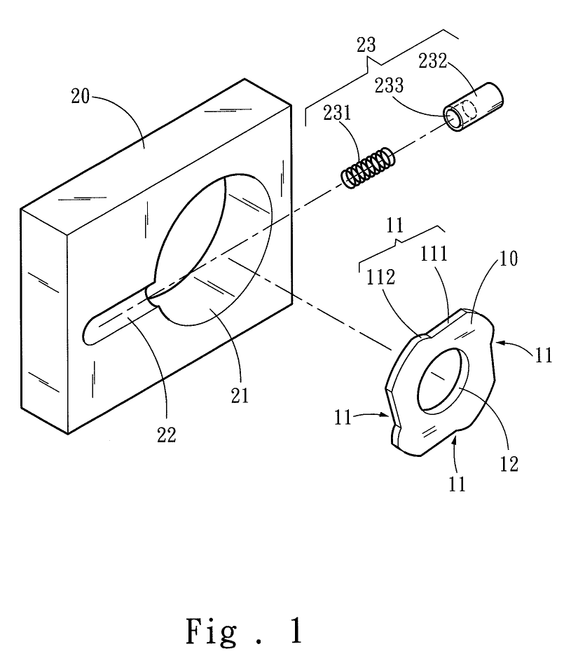

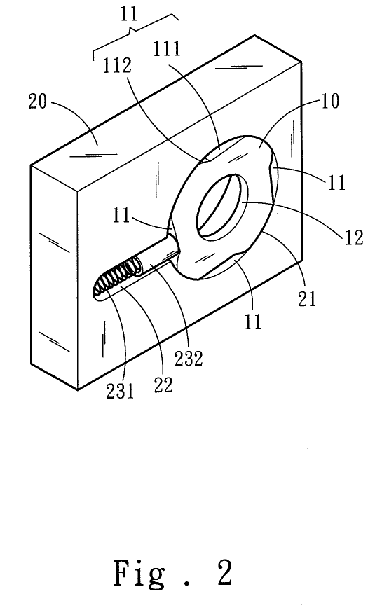

Please refer to FIGS. 1 and 2, the present invention provides a multi-stage magnetic switch which includes a base 20 and a rotary member 10 rotatably hinged on the base 20. The base 20 has a bore 21 and a latch groove 22 adjacent to the side wall of the bore 21. The latch groove 22 holds a latch member 23 which is elastically extended outwards and includes a spring 231 and a strut 232. The spring 231 is held in the latch groove 22. The strut 232 has a cavity 233 to hold the spring 231 in the latch groove 22 so that the spring 231 and strut 232 are coupled together and latched in the latch groove 22. The rotary member 10 is rotatably held in the bore 21 and includes a plurality of latch notches 11 corresponding to and latched with the latch member 23. Each latch notch 11 has a latch plane 111 and an arched convex surface 112 connected thereto. The latch plane 111 and arched convex surface 112 have respectively one side extended to the outer surface of the rotary member 10. The latch member 23 latches on the latch plane 111 and is adjacent to the arched convex surface 112.

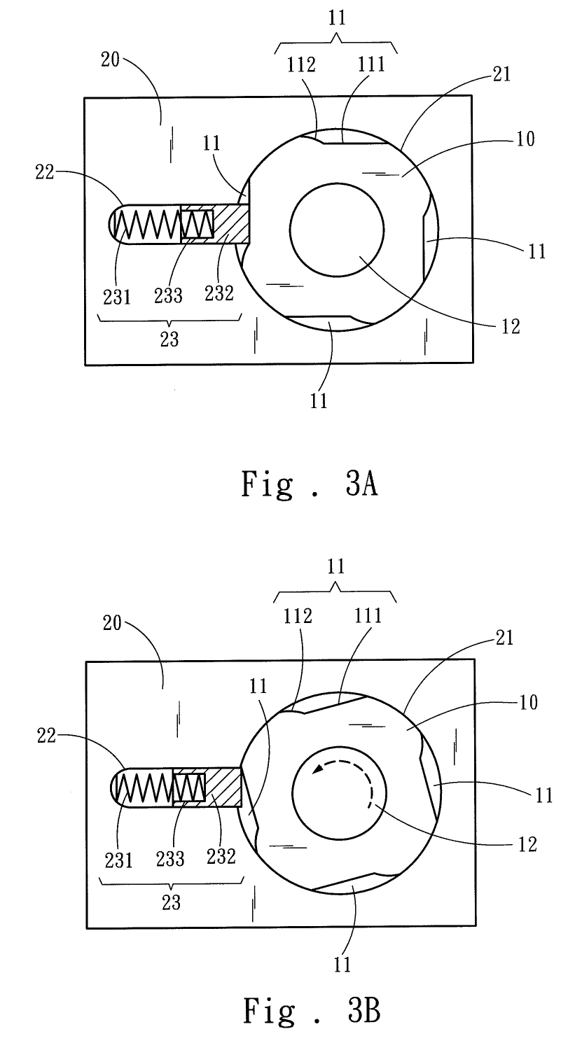

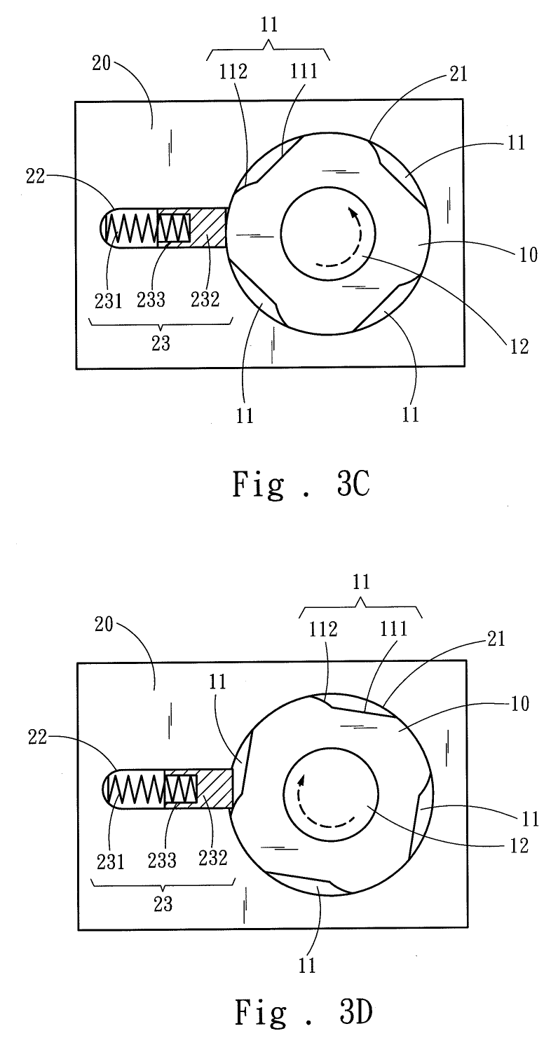

Referring to FIGS. 3A through 3D, when the rotary member 10 rotates, the latch notches 11 also rotate so that the latch member 23 latches in one of the latch notches 11 (referring to FIG. 3A) to anchor the rotary member 10. Next, the rotary member 10 rotates again, and the latch plane 111 presses the latch member 23 to retract the rotary member 10 (referring to FIG. 3B), hence the rotary member 10 can rotate against the base 20 (referring to FIG. 3C). As the rotary member 10 rotates against the base 20, the latch member 23 latches on and removes from the latch notches 11 sequentially to achieve multi-stage positioning function during rotation of the rotary member 10. Moreover, when the latch member 23 is latched on the latch notches 11 to anchor the rotary member 10, greater force can be applied to retract the latch member 23 pressed by the arched convex surface 112 so that the rotary member 10 can be rotated reversely (referring to FIG. 3D).

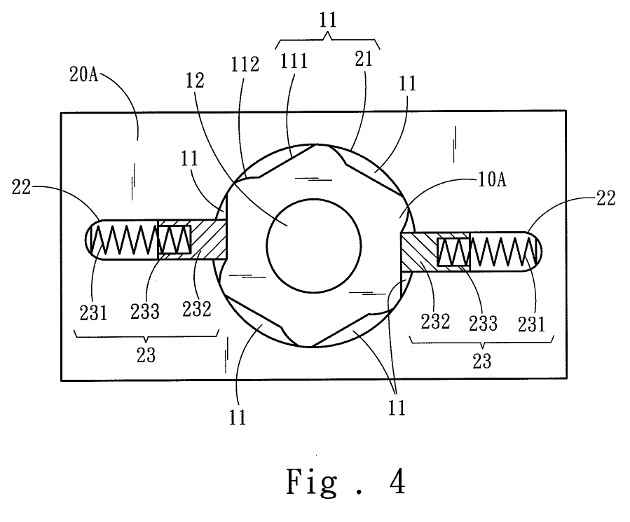

Refer to FIG. 4 for another embodiment of the invention. The base 20A has multiple sets of latch grooves 22 and latch members 23 located thereon. In this embodiment, two sets of latch grooves 22 and latch members 23 and six latch notches 11 are taken as an example for discussion. As previously discussed, the latch members 23 can latch on the latch notches 11 sequentially when the rotary member 10A rotates against the base 20A.

It is to be noted that the latch grooves 22 are arranged and positioned corresponding to the latch notches 11 so that the latch members 23 elastically extended from the latch grooves 22 can latch on the latch notches 11 when the rotary member 10A rotates. In this embodiment, the latch notches 11 are positioned in a positive hexagonal fashion opposing each other. The latch grooves 22 are located at two opposing apexes of the positive hexagon. Such a structure not only provides six-stage positions for the rotary member 10A, but also enhances positioning strength with multiple latching of the latch members 23.

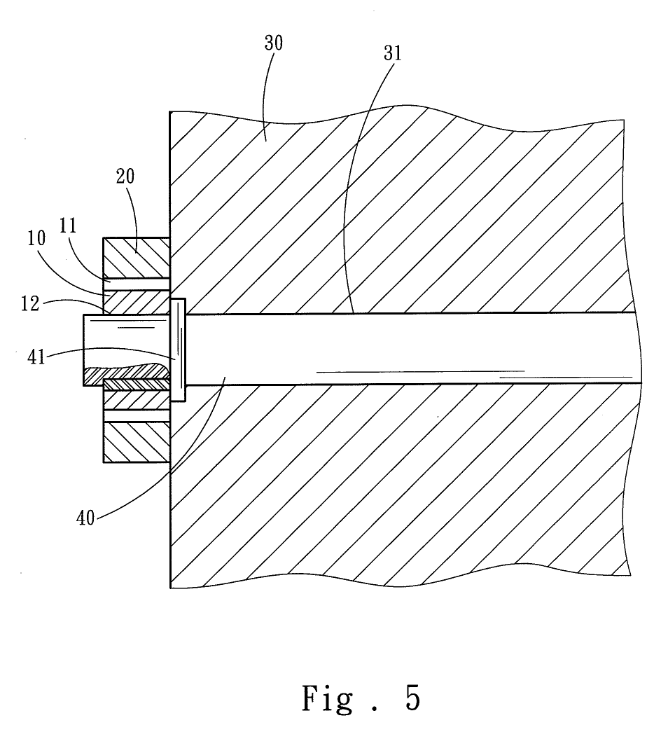

Refer to FIG. 5 for an embodiment of the invention. The base 20 is fastened to a magnetic holder 30 which has a housing space 31. The rotary member 10 has an aperture 12 run through by a shaft 40 held in the housing space 31. The shaft 40 has a latch flange 41 to allow the rotary member 10 to rotatably hinge on the base 20 so that the shaft 40 can rotate in the housing space 31 with the rotary member 10 to achieve multi-stage positioning function.

As a conclusion, through the rotary member 10 hinged on the base 20, the present invention provides a switch fabricated in a simple structure and equipped with clockwise and counterclockwise rotation and multi-stage positioning functions. Thus not only production cost is lower, operation also is easier and durability is longer. As the latch grooves 22 is arranged and positioned corresponding to the latch notches 11, the latch grooves 22 can latch in or remove from the latch notches 11 at the same time. Hence not only the multi-stage function can be maintained, positioning strength of the switch also is enhanced.

What is claimed is:

1. A multi-stage magnetic switch, comprising:
a base including a bore and a latch groove adjacent to a side wall of the bore to hold a latch member elastically extended outside the latch groove; and
a rotary member which is rotatably held in the bore and includes a plurality of latch notches corresponding to and latched with the latch member, each latch notch including a latch plane and an arched convex surface that include respectively one side extended to the outer surface of the rotary member, the latch member being latched on the latch plane and abutting the arched convex surface.

2. The multi-stage magnetic switch of claim 1, wherein the latch member includes a spring latched in the latch groove and a strut to press the spring in the latch groove.

3. The multi-stage magnetic switch of claim 2, wherein the strut includes a cavity to hold the spring.

4. The multi-stage magnetic switch of claim 1, wherein the latch groove and the latch member include respectively multiple sets, the multiple latch members being latched on the latch notches sequentially when the rotary member rotates against the base.

5. The multi-stage magnetic switch of claim 4, wherein the latch members latch on the latch notches simultaneously.

6. The multi-stage magnetic switch of claim 1, wherein the base is fastened to a magnetic holder which includes a housing space, the rotary member including an aperture run through by a shaft which is held in the housing space and includes a latch flange to allow the rotary member to rotatably hinge on the base.
